(19) United States
(12) Patent Application Publication
(10) Pub. No.: US 2012/0326837 A1
(43) Pub. Date: Dec. 27, 2012

(54) Protective Compliance Systems

(76) Inventors: Kemal Ajay, Mount Waverley (AU); Charles Dean Randle, Narre Warren North (AU)

(21) Appl. No.: 13/390,336

(22) PCT Filed: Jan. 12, 2011
(86) PCT No.: PCT/AU11/00027

§ 371 Date: Feb. 14, 2012

(30) Foreign Application Priority Data
Jan. 12, 2010 (AU) 2010900077

(51) Int. Cl. G05B 19/00

(52) U.S. Cl. 340/5.2

(57) ABSTRACT

The present invention provides apparatus and methods for safety compliance in hazardous situations. The apparatus may include sensing means for detecting a first protective apparatus, means for detecting a subject, monitoring means for monitoring engagement of the protective apparatus with the subject; and a controller for controlling operability of a second apparatus according to the monitoring means. Embodiments of the invention include the protective apparatus being eyewear or attenuating sound or radiation. The apparatus may include a power source. The communication between the elements of the apparatus may be by any suitable means, whether fixed line, radio frequency, optical transmission, acoustical, or the like. The invention includes a method for safety compliance comprising the steps of detecting a subject; determining the position of the subject in relation to a protective apparatus; determining the compliance state of the protective apparatus and controlling a second apparatus according to the compliance state.

### FIELD OF THE INVENTION

This invention relates to safety apparatus and methods and, in particular, to personal protective apparatus and methods.

### RELATED APPLICATION

This application claims the priority and benefit of Australian Provisional Application No. 2010900077, filed on 12 Jan. 2010.

### BACKGROUND TO THE INVENTION

It is well known that in many fields of endeavour, occupational hazards exact a considerable toll from workers' well-being. In many regions of the world, there is increasing pressure to provide safer working environments. In an industrial work environment hazards are common. For those working with hazardous apparatus or materials, there are improved safety measures and procedures which have been adopted with the intent of reducing a worker's exposure to danger.

For many years factory machinery has incorporated safety guards to prevent access to dangerous moving parts while a machine is in operation. This is all with a view to trying to eliminate the possibility of accidental injury to operators or other personnel who may find themselves in proximity to such machinery. Examples of well-known safety guards are light curtains, safety gates and interlocks and the like. Such solutions fix protective safety features to the plant or machinery that may pose a hazard.

Where a hazard may be difficult to contain behind a physical guard, personal protective equipment may be used by workers. Examples of such personal protective equipment are safety glasses or safety goggles for the protection of the eyes from projectile material, ear muffs or ear plugs to guard against hearing loss due to high noise levels, reflective outer wear to protect from radiant heat, welding masks to protect the eyes from damage due to ultraviolet radiation and the like.

A well-known example of hazardous machinery is the ubiquitous drill press. A drill-press operator must have clear physical access to the work piece while being able to clearly view the drilling operation. This exposes the operator to the risk of eye injury due to flying swarf or fragments of the work piece. While many drill presses have clear guards installed, these often do not fully cover the work area and in any case may interfere with the handling and placement of the work piece resulting in its removal by the operator. It is often therefore a requirement that the operator of a drill press or lathe or similar machinery wear eye-protective wear such as safety glasses.

Another common hazard is the high noise levels generated by heavy machinery, such as a jack-hammer or timber saw. It is accepted practice to wear hearing protectors in the form of ear muffs when near to such noise sources. Such devices, correctly positioned on a user, can prevent premature hearing loss caused by prolonged exposure to high sound pressure levels.

Unfortunately, it is also well known that, although regulations require the use of protective equipment in many circumstances, there are situations where an operator may either deliberately avoid the use of such equipment or may forget to wear it correctly prior to operating the machinery. Under such conditions the operator may again be exposed to physical hazards.

It is desirable, therefore, to ensure that safety equipment for the protection of operators to be positioned on a user effectively and it is further desirable that if such safety equipment is not being used at all or, alternatively, if such equipment is being used incorrectly, that some action is taken such as shutting down the hazardous plant and machinery or preventing such hazardous plant and machinery from being activated or, at the very least, that an alert is generated so that the operator is reminded to take corrective action to ensure safe equipment or machinery operation.

Fundamental approaches to eye and ear protection are well established and known to those skilled in the art. There are many disclosures relating to enhancements to established practice in the area of eye and ear protection. For example, Brown et al. (U.S. Pat. No. 5,278,999) disclosed an invention which combines ear and eye protection in a single device. Graham, (U.S. Pat. No. 5,243,711) discloses an eye shield with features directed at hazards associated with hair spraying and hair styling. Hartley et al. (U.S. Pat. No. 7,008,056) disclose an invention to provide both ballistic and light eye protection. There are other inventions such as by Falco et al. (U.S. Pat. No. 7,464,786) which discloses a hearing protection device providing high sound attenuation.

Heller et al. (WO/2009/081340) disclose a system using image processing methods to ensure that protective equipment is being positioned on a user. The system disclosed analyses images looking for key indicators that protective equipment is present. The system has the disadvantage that requires that protective equipment be visible. Therefore, if such equipment is positioned on a user under clothing or under another piece of equipment it will not be detected.

What is needed are methods and apparatus to promote better user compliance with the requirements for correct application and maintenance of safety precautions.

### SUMMARY OF THE INVENTION

A problem with the aforementioned solutions and others generally known in the art is that they rely on an operator to ensure that protective apparatus and methods are used appropriately. If the intended user does not apply such apparatus and methods correctly then the protection afforded is reduced and may not prevent injury. Embodiments of the invention provide a plurality of solutions to the problem of controlling potentially hazardous apparatus dependent on compliant positioning of apparatus for operator safety during hazardous apparatus operation.

It is an object of this invention to provide means to monitor the use of protective apparatus for use with hazardous apparatus. Such apparatus is usually positioned on a subject to enhance safety during the operation of hazardous apparatus. In this document, hazardous apparatus may comprise of, without limitation, such apparatus as machinery, welding apparatus, loud apparatus, hot apparatus, radiation-emitting apparatus, and the like. It is a further object of the invention to monitor the engagement of such apparatus with the subject. It is a further object of the invention to monitor that the apparatus continues to be correctly positioned on a user. It is a further object of the invention to control the operation of the hazardous apparatus depending on the status of the monitored apparatus. It is a further object of the invention to raise an alert or otherwise provide a signal that may be used to protect persons from exposure to hazards while operating hazardous apparatus. Other objects will become clear on reading the disclosure of the invention appended hereto.

The invention may most advantageously provides apparatus for regulatory compliance comprising of detection means for detecting a first apparatus, detection means for detecting a subject, monitoring means for monitoring engagement of said first apparatus with said subject, and controller for controlling the operability of a second hazardous apparatus according to said monitoring means. The detecting means includes sensing means for sensing a subject. There are many applications in which embodiments of the invention will be useful to monitor and enforce compliance with good safety practices. Some of the embodiments are described in this document. In addition, the invention may most advantageously provide a method for safety compliance comprising the steps of detecting a protective apparatus, detecting the position of said protective apparatus, engaging said protective apparatus with a subject, and controlling hazardous apparatus according to the position of said protective apparatus.

In one aspect the invention provides compliance apparatus comprising of a protective apparatus, detecting means for detecting a subject; and decision-making means for outputting a compliance indication. The detecting means may be a suitable sensor. The compliance apparatus may further comprise of a controller for receiving the compliance indication from the decision-making means. The decision-making means may be any suitably programmed microprocessor. The compliance apparatus may further comprise of a driver. The controller and driver may comprise a single device. The compliance apparatus may comprise of an interface activated by the driver for communicating with a second apparatus. The second apparatus may be machinery or equipment any other type of apparatus which requires protective apparatus to be used in conjunction with its operation. The interface may be a relay. The interface may be in communication with a second apparatus, such as the afore-mentioned machinery, or equipment, or other apparatus.

The detecting means for detecting the subject may provide a sensing output when in proximity to certain anatomical features of the subject. The detecting or sensing means for detecting the subject may conform to certain anatomical features of said subject. The detecting or sensing means may be any suitable sensor for sensing parameters characteristic of a subject. The sensing means may include a plurality of sensors for sensing a plurality of parameters.

In another aspect, the invention may provide apparatus comprising of sensing or detection means for detecting a first protective apparatus, detection means for detecting a subject; monitoring means for monitoring engagement of said protective apparatus with said subject; and a controller for controlling the operability of a second apparatus according to said monitoring means. The controller may be a suitably programmed microprocessor. The invention includes the protective apparatus being eyewear. Alternatively, the protective apparatus may attenuate or reflect sound. Alternatively, protective apparatus may attenuate or reflect x-rays or other harmful radiation that may impinge a subject. The protective apparatus may protect against further types of hazardous phenomena such as gases or the like.

The apparatus may include a power source. The communication between the elements of the apparatus may be by any suitable means, whether fixed line, radio frequency, optical transmission, acoustical, or the like. The elements of the apparatus may be linked, the linking may be with codes.

In another aspect, the invention may provide a method for safety compliance comprising the steps of detecting a subject; determining the position of the subject in relation to a protective apparatus; determining the compliance state of the engagement of the protective apparatus and controlling a second apparatus according to the compliance state of the protective apparatus. The protective apparatus may be any type of protective apparatus useful for preventing injury in hazardous situations.

In a further aspect, the invention may provide a method for safety compliance comprising the steps of detecting a first apparatus, detecting the position of the first apparatus; engaging the first apparatus with a subject; and controlling a second apparatus according to the position of the first apparatus. The first apparatus may most advantageously be a safety apparatus. The controlling step may include preventing the operation of the second apparatus according to the state of the first apparatus.

### BRIEF DESCRIPTION OF THE DRAWINGS

FIG. 1 shows the invention as a system block diagram.

FIG. 2 shows an embodiment of the invention for protective eyewear.

FIG. 3 shows detail on an embodiment of the invention as it relates to protective eyewear.

FIG. 4 shows an embodiment of the invention for the purposes of hearing protection.

FIG. 5 shows an embodiment of the invention for the purposes of protection from stray x-radiation.

FIG. 6 shows an embodiment of invention incorporating Radio Frequency Identification (RFID) technology.

FIG. 7 shows an embodiment of a sensing and transmitting circuit for a compliance apparatus.

FIG. 8 shows an embodiment of a receiving and controlling circuit for a compliance apparatus.

FIG. 9 shows a diagram of an embodiment of a user interface for the receiving and controlling unit for a compliance apparatus.

FIG. 10 shows a flow chart detailing the safety interlock aspects of the receiving and controlling unit.

FIG. 11 shows an example of localisation using a wire loop.

FIG. 12 shows an example of localisation using Time of Flight.

FIG. 13 shows an example of localisation using directional antennae.

FIG. 14 shows localisation using optical means.

FIG. 15 shows an embodiment of a compliance apparatus combining separate operator identification with protective device type.

### DETAILED DESCRIPTION OF THE INVENTION AND PREFERRED EMBODIMENTS

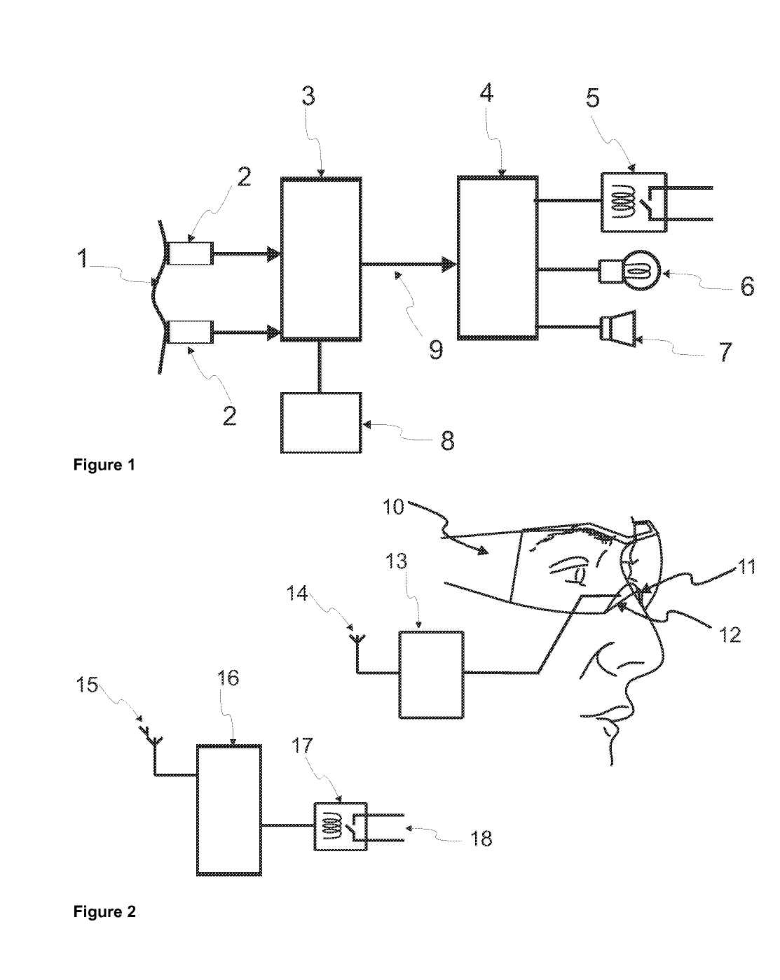

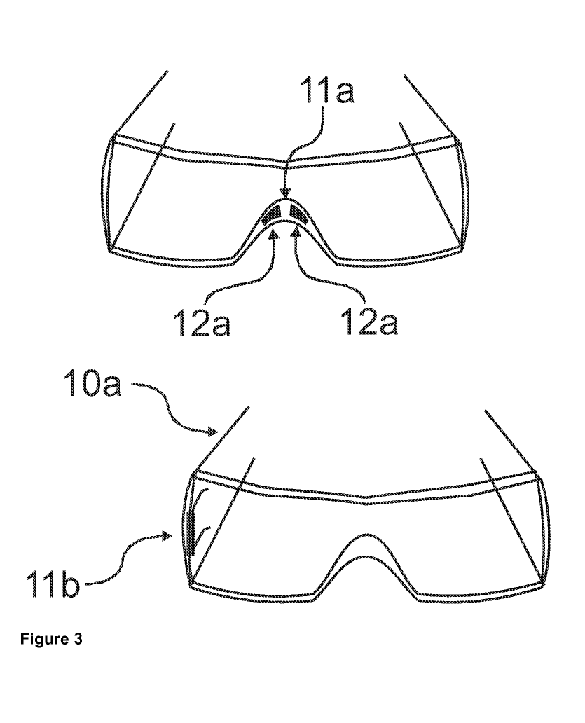

The inventive concept is summarised in FIG. 1 and illustrated in more detail, including various embodiments of the invention, in the succeeding Figures. It will be understood that the description herein of various embodiments of the invention are specific, non-limiting, examples for illustrative purposes. The embodiments are included herein to provide examples of performance of the invention and must not be construed to be limiting the invention to these embodiments. It will be understood that the scope of the invention is limited only by the claims appended hereto.

This invention provides apparatus and methods for monitoring compliance with the correct application of personal protective equipment comprising of at least one sensing means for determining if apparatus, such as personal protective equipment, is substantially correctly positioned, such as in close proximity to a subject, such as an operator of hazardous equipment, or a subject who could be injured by hazardous equipment were the protective equipment not correctly positioned. Preferably, said sensing means is shaped (1) at least in part, to conform to certain anatomical contours or features of the wearer in the vicinity of the physical areas to be protected. Preferably at least one detection means (2) is mounted within or adjacent said sensing means. Preferably, a sensing output of said sensing means detects the spatial positioning of said physical area and said anatomical features. The invention further comprises of decision-making means (3) operating on said sensing output(s) to produce a decision output indicative of the state of engagement of the protective apparatus indicative of the compliance of the protective apparatus. The state of engagement is preferably either one of complying with correct application or of not complying with correct application. Preferably, the decision-making means provides said decision output (9) based on at least one input. The invention may further comprise of a controlling and driving device (4) so arranged as to receive said decision output. The controlling and driving device preferably comprises of at least one interface. Preferably the at least one interface is a relay (5) to enable or disable hazardous apparatus or other output. Preferably the interface activates an alerting means. Preferably, the alerting means is a light (6) or a sounder (7). Preferably the alerting means is dependent on the state of said decision output. Preferably the apparatus further comprises of a power supply (8) for supplying power to the electronics.

In another embodiment of the invention the decision-making device (3) and the controlling and driving device (4) are combined into one device.

In yet another embodiment of the invention, provision is made for the addition of an adjustable delay to delay any interface activation or notification output, where the range of said adjustable delay includes zero delay.

In yet another embodiment of the invention a means of wireless communication forms at least one of the links between the detector(s) (2) and the interface driver (4). Said wireless means of communication may be any of a radio or optical or acoustic link. This affords the advantage of allowing the wearer of the protective equipment freedom of movement.

In yet another embodiment of the invention provision is made for determining the proximity of the wearer of the protective equipment with respect to hazardous apparatus so that only the apparatus intended to be used by the wearer is enabled and that any other hazardous apparatus nearby is not enabled by the wearer.

In one embodiment of the invention, and in reference now to FIG. 2, a pair of protective eye glasses (10) is fitted with a detector means (12) on the nose-bridge of the eyeglasses (11). The presence of the nose within the bridge of the eyeglasses may be detected by the detector means, which may comprise of any detection means, such as resistance measure, capacitance measure though the use of electrodes, optical measure using illumination and receiving optical devices or acoustic measure through the use of vibratory transducers or a switch mechanism.

The fitment of the nose within the bridge of the eyeglasses effects any one or any combination of the aforementioned detection methods by virtue of proximity or by virtue of contact or pressure resulting in a sensing output. Electronic module (13) accepts the aforementioned sensing output and generates a transmitted signal via an antenna (14) although the communication means maybe any suitable, such as a cable, radio link, optical link or acoustic link. The transmitted signal is received by a monitoring device (16) via a receiving antenna (15) as an indication that the protective eyeglasses are being correctly positioned on a user, which consequently activates a display device such a light, or activates a control device such as a relay (17) to control hazardous equipment. The subsequent removal of the protective eyeglasses from the bridge of the nose may be indicated via the same communication means and used to reverse the state of display devices or of the control relay.

The invention most advantageously includes combining detection methods in the detection means and sensing sites by the operation of a decision-making means. This may ensure that the sensor arrangement does not malfunction in situations where an inanimate object is placed in any one of the wearer's features. For example, additional sensor sites fixed to the eyeglass hinges may determine if the wings of the glasses are fully extended as would be the case if being correctly positioned on a user.

In an alternate embodiment, at least one arm (10a) may be fitted with a switch (11b) which changes state depending on the position of said arm. A bias force, provided by a suitable means such as a spring or simply by the moulding process for the glasses, ensures that when the glasses are not being worn, the switch is in a state to reflect that the glasses are not being worn. Advantageously, this switch may be a power interruption switch which provides the benefit that when the glasses are not being worn, no power is consumed by on-board circuitry thereby offering extended battery life.

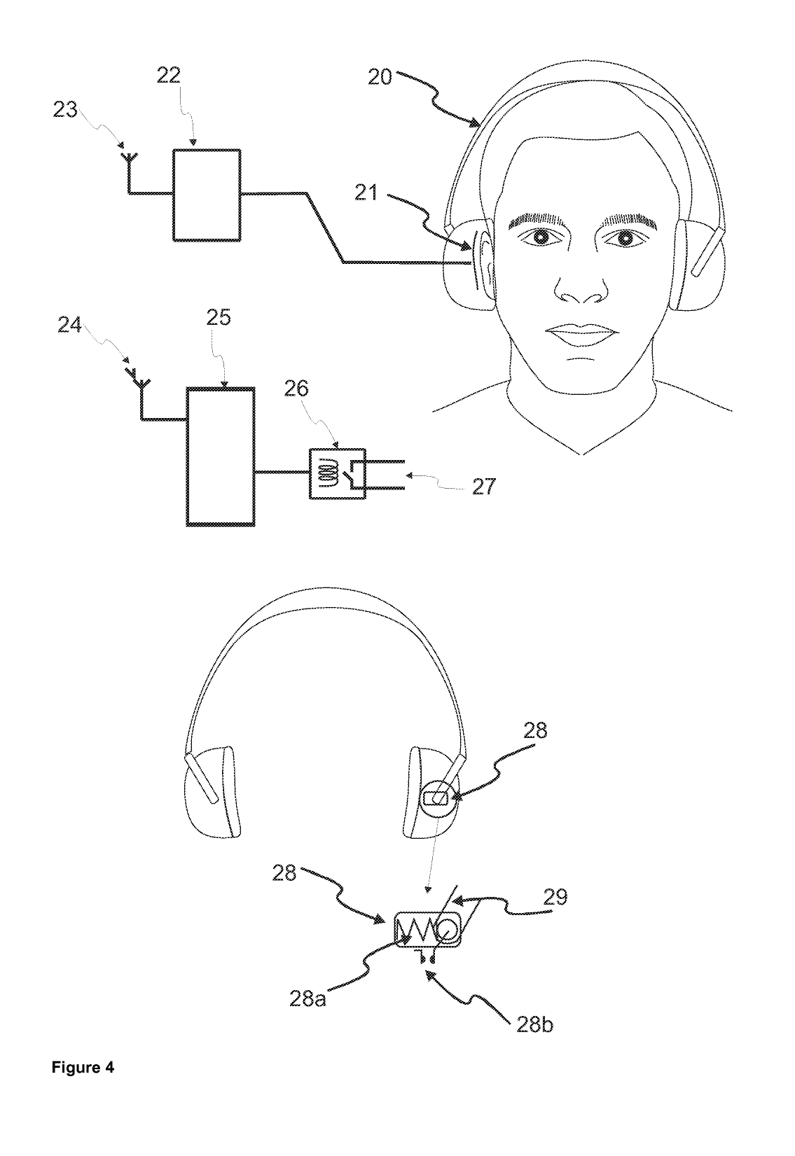

Now with reference to FIG. 4, another embodiment of this invention is described. In this embodiment a noise cancellation means, such as a pair of earmuffs (20) is fitted with a detection means (21) which detects the presence within the cup of the earmuffs of at least one physical feature of the ear such as the pinna. Said detector (21) is preferably simply a capacitive plate but may be a detection means governed by any of inductance or resistance, or may be by haptic methods using a displacement or pressure detector or by acoustic methods. It may be of advantage in to combine several such detection methods to form a more robust decision regarding the correct application of the earmuffs to the ears. Such detection methods may comprise of temperature detectors or sensors, for example, A controller (22) is connected to the detector (21) and determines if there is the presence of the feature of an ear within the cup. The cup structure, supporting the ear detector comprises the sensor in this case. When the sensor signal indicates that the ear is correctly positioned within the cup the controller transmits a radio signal via antenna (23). The transmission is received by receiving antenna (24) and interface driver (25) activates a relay (26) to permit operation of noisy apparatus. Alternatively the detection means may be a simple switch (28) or pressure detector in the headband or in the ear cups that indicates that headband is under stress, rather than being in the relaxed state, indicating that the earmuffs are being positioned on a user, said switch or pressure sensor being comprised of, for example, a bias spring (28a) pushing against the headband (29) this separating contacts 28b. Note that said switch may simply a power switch which controls power to the on-board circuitry advantageously combining the aforementioned sensing function with the benefit of power saving when the protective equipment is not being worn.

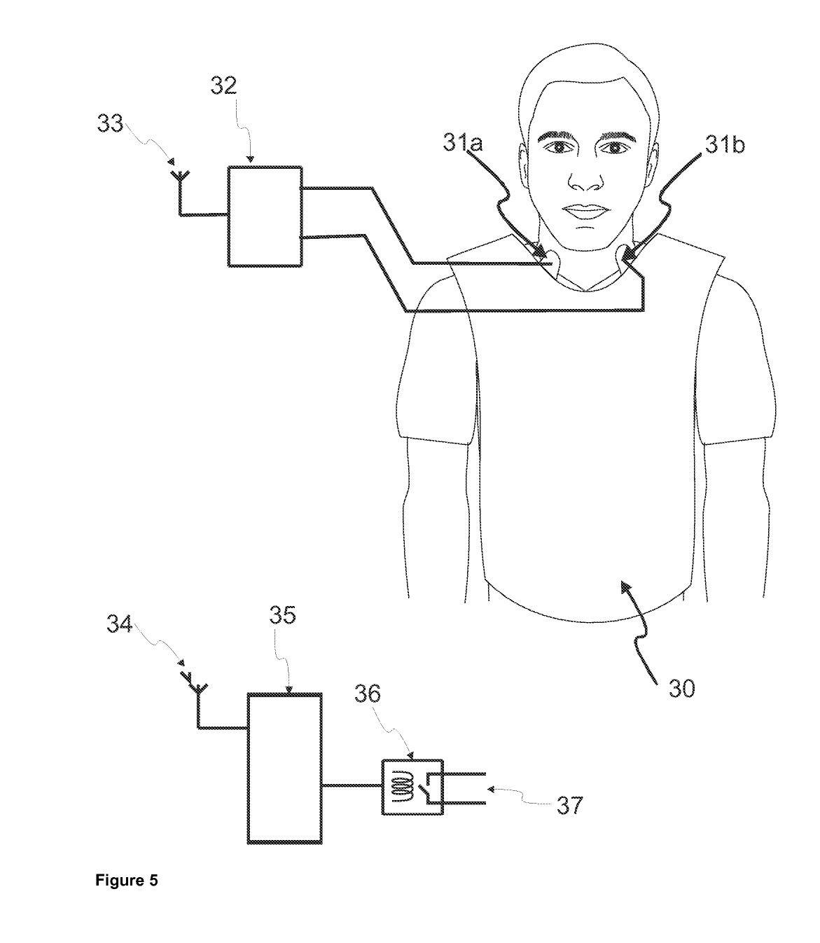

A further embodiment of this invention is described here with reference to FIG. 5. It is frequently required for patients to undergo diagnostic x-rays such as at a dentist, or for chest x-rays, mammograms, or the like. It is normal practice in such situations for the patient to be provided with a dense, lead apron (30) to absorb stray x-rays. The apron is in this instance may be fitted with a sensor (31a or 31b) or a plurality of sensors (both 31a and 31b) consisting of a physical structure and internal detector(s) so placed as to detect the presence of the a part of the body such as the neck of the patient when said sensor(s) are in close alignment with the neck. Controller (32) reads the sensor information and if it is deemed that the sensors are indicating the correct positioning of the apron a radio signal is transmitted via a transmission means, which is preferably an antenna (33). This transmitted radio signal is received by antenna (34) and processed by interface driver (35) to activate relay (36) which in turn engages contacts (37) which may be used to enable the x-ray machine. In this way, if the lead apron is being positioned on a subject correctly, then the x-ray machine is enabled to operate otherwise it is disabled.

Embodiments of this invention may incorporate a switch means to turn the power on and off within the personal protective equipment. This has the advantage of reducing power consumption when the protective equipment is not in use thus extending the life of any expendable power source that may be required.

### Power Sources

As the invention detects the presence of the wearer and then by some means notify that the protective equipment is positioned correctly, it is necessary to have access to power to operate the circuitry within the protective equipment. There are many possible power sources that may be incorporated into embodiments of the invention.

In one embodiment, power may be provided to the personal protective equipment via a cable or system of cables connected to a fixed power source such as a bench or equipment-mounted battery or power supply. While such an approach would restrict the movement the wearer of the protective equipment, it has the advantage that the same cable or system of cables can act at the communication medium to signal that the protective equipment is being correctly positioned.

In another embodiment, the power may be provided through cable connected to a portable power source positioned for use by the person wearing the protective equipment. The power source may be, for example, a battery pack. Preferably, the battery pack is belt-clipped. This embodiment has the advantage that it improves the freedom of movement of the wearer but has the disadvantage that it is more cumbersome to engage and disengage.

In a further embodiment of the invention, power may be provided through an on-board battery fitted to the personal protective equipment. This embodiment has the advantage that it allows maximum freedom of movement to the wearer.

In yet another embodiment, power may be provided through radiated energy. This may take the form of radio frequency energy from a nearby source or simply scavenged from background electromagnetic radiation. Alternatively the energy source may be light which can be converted to useful power though photovoltaic cells.

In yet another embodiment of the invention, power and communications may be provided using Radio Frequency Identification (RFID) technology. This provision may be either totally passive, wherein all of the power required is provided by the interrogating RF field, or the power source may be enhanced using a battery.

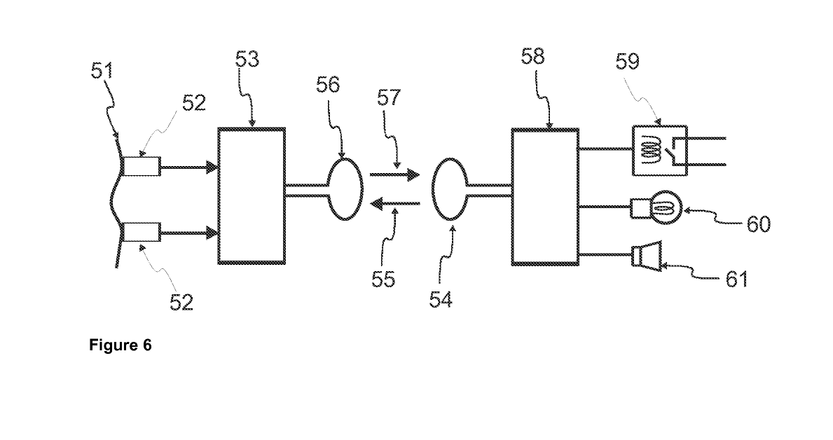

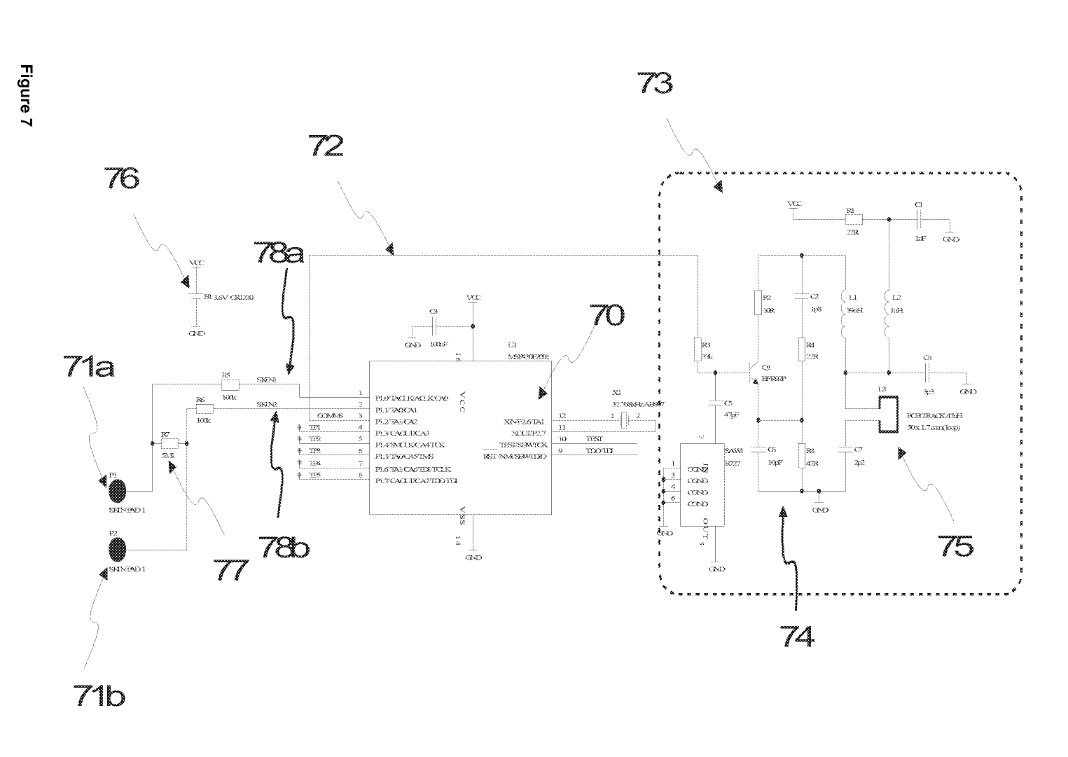

FIG. 6 shows a diagram of an embodiment of the invention, being a personal protective equipment monitoring system using RFID Technology. Supporting structure (51) is fitted with detector (52) providing a signal related to proximity of the areas to be protected to controller (53). The controller (53) has antenna (57) for receiving RF energy (55) from interrogator (58) via antenna (54). This energy may be used to power the controller (53) and detectors (52) as required. If the sensors (52) and subsequently controller (53) indicate that the protective equipment is properly in place then the controller may transmit a positive response (57) to the interrogator which may, on receipt, activate a relay (59) to enable hazardous equipment to operate or turn on a light (60) or sounder (61) to indicate that the protective equipment is in place.

### Coding

Most advantageously, any embodiment of the invention may incorporate means to identify the particular linked apparatus, either protective equipment or monitoring means. Preferably, the link is by way of a key which may be a specific code transmitted from the protective equipment to monitoring means. Preferably the link is implemented by a computer algorithm which may generate the code. In this way, through the use of a data base, it can be confirmed that the protective equipment is suitable for use with the hazardous equipment or environment that the wearer is about to encounter. For example, a drill press would require protective eyewear rather than hearing protection so it is of value for the monitoring or control equipment to be able to distinguish between the different types of protective equipment through the use of transmitted codes.

The key may be transmitted by the use of RFID technology. RFID technology can provide the benefit that a particular set of protective apparatus is identified for use with particular equipment. Thus the presence of a particular RFID tag number can be compared with a database of protective equipment compatible with the equipment being used and prevent use of, or access to, the potentially hazardous equipment if the personal protective equipment is not in the compatibility data base.

The database may further be used to link operator skills with permission to use hazardous equipment. For example if an operator is issued with a pair of safety glasses for their exclusive use, and if the safety glasses have a unique identification or serial number associated with that individual in a data base, then the database may be consulted by a management system in order to determine if that individual has permission to use that equipment. For example an individual may be trained in using a drill press but not in the use of a lathe. Therefore, although the individual is wearing safety glasses the database will return a negative result if he/she attempts to use the lathe and it will remain inactive.

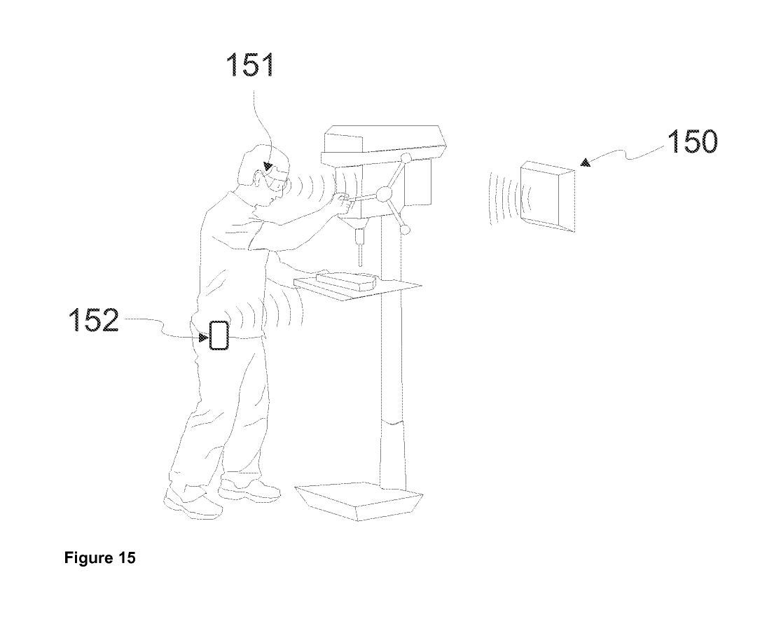

In another embodiment, the identification of the individual wearing protective equipment may be achieved with a separate means, such as a separate RFID tag or bar code or any other means that may be associated with the individual, and the monitoring system may combine information from the wearer's personal identification with the nature of the protective equipment to determine of hazardous equipment should be enabled. Thus, referring to FIG. 15, receiving system (150) receives identification signals from protective equipment (151) and from a personal identification tag (152).

### Localisation

In embodiments incorporating wireless communication means, it is desirable to limit the range of operation to be within a distance range of the apparatus or hazard intended to be accessed. This is to avoid the possibility of a wearer of protective equipment working at one location, activating an enabling response in an adjacent location.

For example, it is undesirable for a person wearing personal protective equipment and operating a drill press, causing the activation of the enabling circuitry of a nearby lathe. There are a number of methods that may be used to enforce locality, herein after referred to as localisation. Some of the embodiments are described hereinbelow.

### Localisation by Induction Loop

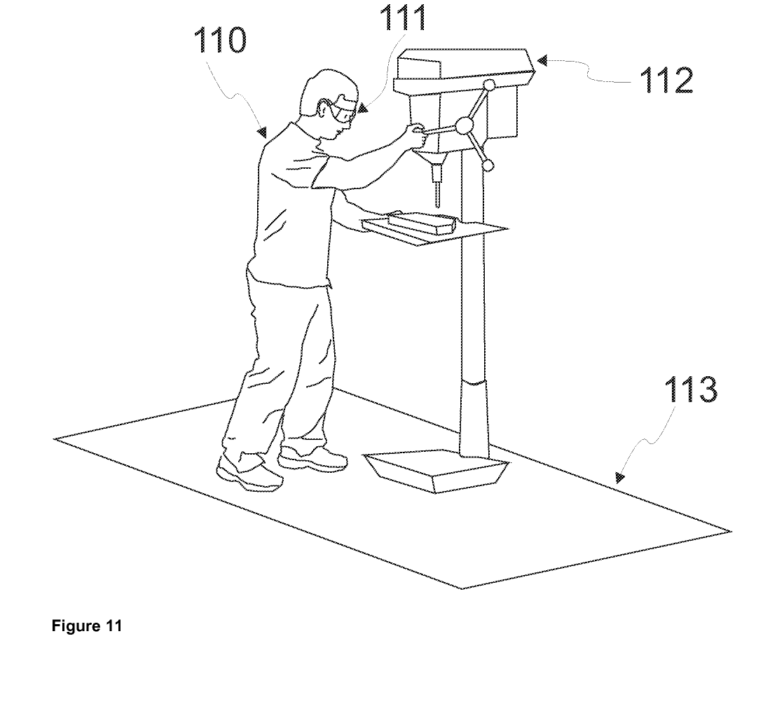

The use of a wire loop enclosing an area is a very effective way of localising electrical coupling. Referring now to FIG. 11 an operator (110) operates a drill press (112) while wearing protective eyewear (111) which has within it a portion of an embodiment of the present invention. A perimeter wire loop (113) is placed suitably around the hazardous apparatus to pick up signals transmitted from the eyewear (111). Magnetic coupling between the loop and a transmitting coil is strongest when the eyewear is within the loop and falls off rapidly as it is moved outside the loop. Thus a small inductive loop around the desired operator position for hazardous apparatus is an effective means of ensuring that an operator is at the correct location.

### Localisation by Time-of-Flight

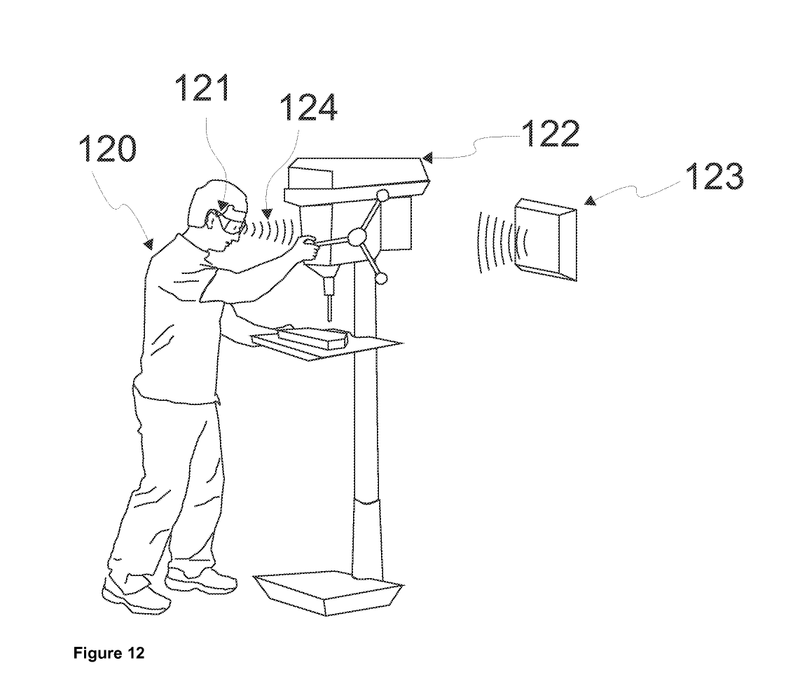

Referring now to FIG. 12 a pulsed transmitter (123) emits electromagnetic or ultrasonic signals. The eyewear (121) receives said signals and responds with a return signal (124) which is keyed to the transmitter so that the transmitter can identify the eyewear as valid for the current area of operation. The measured time taken for the sequence of transmission from (123) and the arrival of the response signal (124) is a direct indicator of distance and thus a measure of location of the eyewear with respect to said pulsed transmitter. If this time within expected limits then the eyewear is considered to be within the area of operation.

### Localisation by Directional Antenna

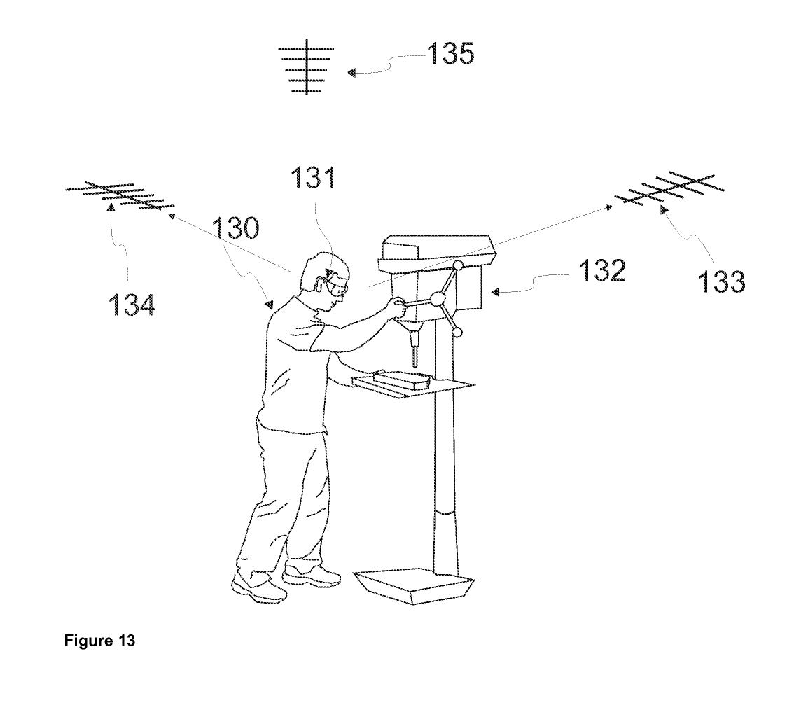

Referring to FIG. 13 directional antennae (133 and 134) may be oriented so that their peak sensitivities are made to intersect at the expected area of operation. Thus, transmissions from eyewear (131) in said intersection will be received by both antennae indicating that the operator is in the area of operation.

Alternatively it would be possible to use a single antenna (135) positioned vertically above the area of operation to achieve a similar result.

### Optical Field of View

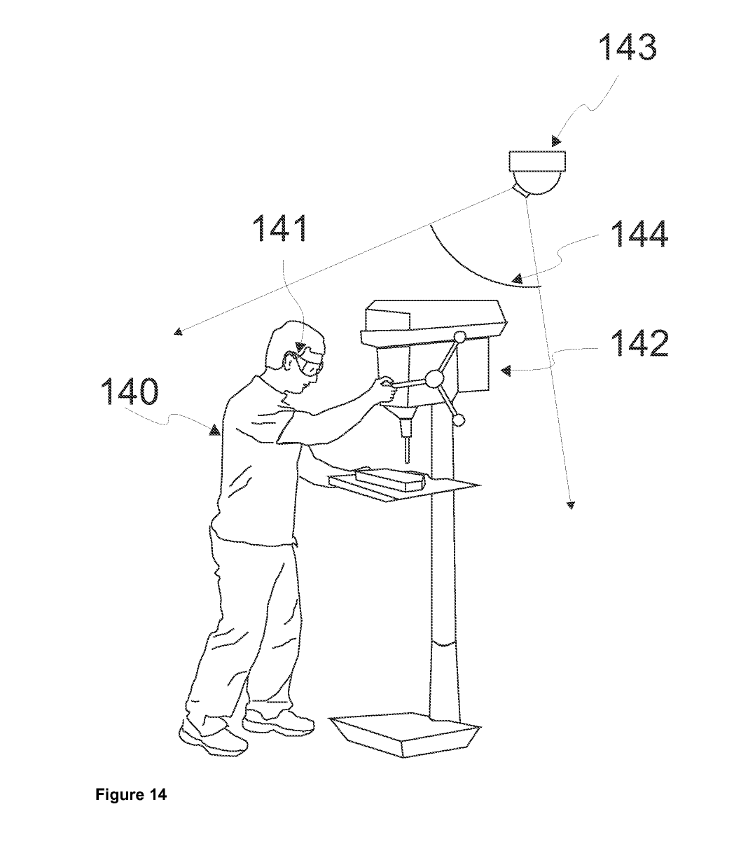

Referring to FIG. 14, an optical receiver (143) is positioned such that it has a field of view (144) which covers the area of operation. An infra-red beacon mounted in eyewear (141) periodically sends a coded sequence to the receiver (143) to indicate that it is in the area of operation.

### Avoiding Interference

It is well known to those skilled in the art that radio frequency links can be subject to interference from external radiating sources. Such sources may be other electronic equipment such as computers, hand-held cellular telephones or transceivers or the like. Interference can result in loss of communications and would therefore cause equipment to shut down unnecessarily. In the contrary case, if the interference were to be mistaken for a valid transmission from the protective equipment, it may allow the hazardous apparatus the opportunity to be started without the protective equipment in place. The use of coded transmissions, mentioned hereinbefore, alleviates the latter problem since the hazardous equipment will only be enabled to be operated if its associated monitoring equipment has received a valid code.

In order to minimise effects of interference in general, it is of advantage to utilise anti-jamming methods in the radio transmissions. Two such methods, known to those skilled in the art as Spread Spectrum techniques, are Frequency Hopping and Code Spreading. Both of these techniques provide significant resistance to interference and may be readily implemented and are described in many publications including, for example, “Spread Spectrum Communications Handbook.” By Simon et al. See also Blashalg (U.S. Pat. No. 4,231,113) and Purington (U.S. Pat. No. 2,635,228).

### Most Preferred Embodiment

A description of the most preferred embodiment is provided here with respect to its application in the area of protective eyewear. As mentioned hereinbefore the scope of the comprises of a plurality of embodiments wherein the personal protective equipment required to be positioned on a user may be constructed in such a way that the protective equipment can detect the presence of at least one physical feature of the wearer, therefore this description of the most preferred embodiment shall not be considered to be limiting the invention to a particular embodiment.

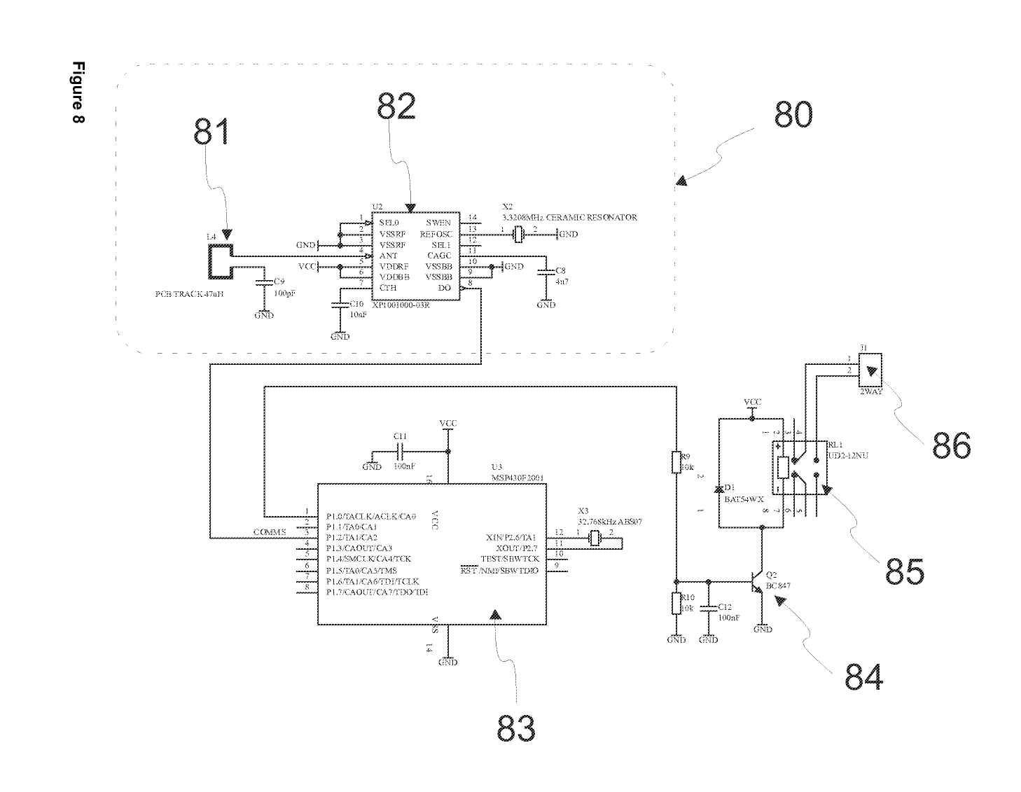

With reference to the attached figures, a physical structure (1) which, for example, may take the form of the nose bridge section (11a) of a pair of safety glasses, is fitted with a pair of capacitive plates (12a) in the form of small metal areas embedded within said nose bridge and connected to circuitry as represented by 71a and 71b in FIG. 7. When said safety glasses are correctly worn, the nose of the wearer presents a mass of high dielectric constant material to said plates resulting in an increase in measured capacitance. Details of a suitable capacitive sensing method are disclosed in Eichelberger et al. (U.S. Pat. No. 4,290,052) and Bobick (U.S. Pat. No. 4,103,252) among others.

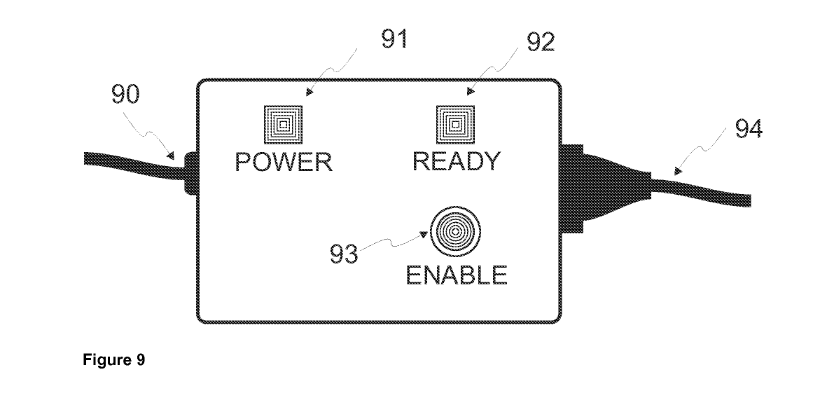

Referring now to FIG. 7, capacitive plates (71a and 71b) are connected to two port pins of microcontroller (70). Initially, microcontroller (70) switches a first line (78a) at a frequency of about 10 kHz while setting the other port pin connected to a second line (78b) to be an input. Current from the switching line (78a) bleeds to the non-driven plate (71b) through a 5.1 megohm resistor (77), thus charging and discharging the non-driven plate (71b) and consequently the microcontroller input connected to line (78b). By measuring the time taken from a transition on the first drive port line (78a) to a detected transition on the second line (78b) it is possible to measure the capacitive load presented by non-driven plate (71b) which is in turn dependent on dielectric constant and amount of material near it. As the bridge of the glasses is placed on the nose of the wearer, the capacitance of the non-driven plate (71b) will increase substantially. Subsequent to the initial process, the opposite process may be applied with line 78b being driven and line 78a measured. If both the initial and subsequent measurements are in accord then the controller (70) decides that the protective equipment is being positioned on a user correctly and then activates the radio transmitter section (73) using the port pin connected to the ‘COMMS’ line (72). The radio transmitter section is comprised of a SAW stabilised single transistor oscillator (74) feeding a loop antenna. The radio transmitter section (73) is activated while the ‘COMMS’ line (72) is driven high and deactivated when the ‘COMMS’ line is driven low. In this way, a simple on-off keying (OOK) is achieved. It will be clear to those skilled in the art that this is a basis for transmitting codes which may be received and compared for validity by a suitable receiving circuit. Thus, once the microcontroller (70) has determined that the protective equipment is being correctly positioned on a user, a code is transmitted to a receiving circuit (16 in FIG. 2) shown diagrammatically in FIG. 9 which will permit the operator to start the hazardous equipment.

### Safety Interlock Sequence.

Note that it is undesirable to allow hazardous apparatus to start simply as a result the act of putting on protective equipment. This would result in the possibility of injury due to the sudden and unexpected activation of such apparatus. It is most desirable that as well as the act of putting on the protective equipment, there should be a subsequent action by the operator to deliberately turn on the hazardous apparatus. Any attempts to turn on the hazardous apparatus prior to proper application of the protective equipment would be disregarded, other than to optionally issue a warning to the operator to put on the protective equipment.

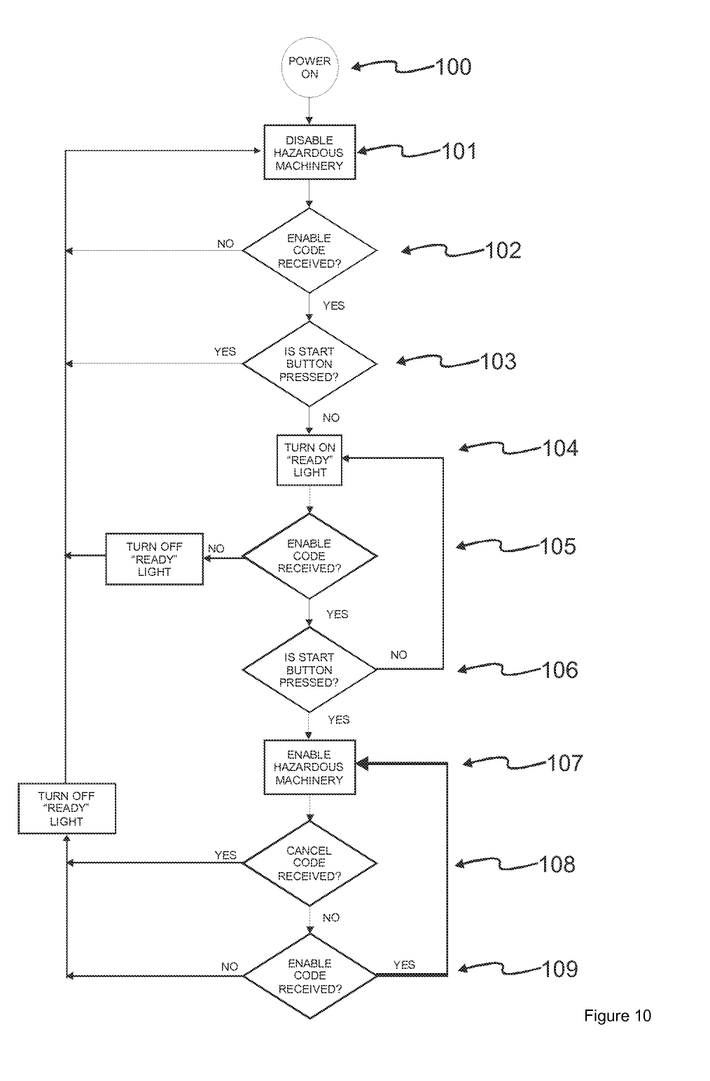

In addition, if the hazardous apparatus were to shut down in response to the protective equipment not being correctly positioned on a user, then the safety interlock sequence would be reset, requiring the operator to deliberately restart the hazardous apparatus once the protective equipment was properly in place. This logic is shown as a flow chart in FIG. 10 and is explained hereinbelow with additional reference to FIG. 9.

It can be seen in FIG. 9 that the receiver has a power input (90) and a power indicator light (91) that illuminates when power is available to the unit. The ‘READY’ indicator light (92) illuminates if a valid code is being received from the corresponding protective equipment. When the ‘READY’ indicator light (92) is illuminated, the operator may press the ‘ENABLE’ button (93) momentarily which will result in power being available at the power outlet (94) to the hazardous apparatus.

A more detailed description of safety interlock logic is now given with reference to FIG. 10.

The logic begins at the application of power to the receiver (step 100). The first action taken is to disable power to the hazardous equipment (step 101) as the default safety state. The next step (102) looks for the arrival of a valid code, which would signify that the protective equipment is now being positioned on a user. If the valid code does not arrive flow reverts back to the previous step (101). If a valid code is received then the logic checks the ‘ENABLE’ switch (93) to determine that it is the un-pressed state (step 103). This is to ensure that the switch is not stuck in the pressed position which may otherwise cause power to be applied to the hazardous apparatus unexpectedly. If the aforementioned ‘ENABLE’ switch is in the un-pressed state, the flow proceeds to turn on the ‘READY’ light (92) and wait for a delay (step 104), such delay time being sufficient to allow for reception of a valid code which is being regularly transmitted from the protection equipment. At step 105, if a valid code is not received by the end of the fixed delay, the system turns off the ‘READY’ light (92) and the logic resets to step 101. Alternatively, if a valid ‘enable’ code has been received then the system checks to see if the operator has pressed the ‘ENABLE’ switch (93) at step 106. If the switch has not been pressed, logic reverts to step 104. If, however, the switch is found to be pressed then the logic advances and enables power to the hazardous apparatus (step 107). Thereafter, the system regularly checks for the arrival of ‘cancel’ code (step 108) or an ‘enable’ code (step 109). If a ‘cancel’ code is received or if the ‘enable’ code ceases to be sent then the logic clears the ‘READY’ light reverts to step 101, which results in disabling power to the hazardous apparatus.

Note that the use of the ‘cancel’ code is provides the benefit of faster speed of response as it is not necessary for the monitoring equipment to wait for a period of time to determine that valid ‘enable’ code has not arrived and thence disable the hazardous apparatus. For less time-critical applications the use of a ‘cancel’ code is not necessary and so step 108 could be deleted which may save some complexity and consequently cost.

Clearly, as persons skilled in the art may readily effect modifications within the spirit and scope of the invention, it is to be understood that the invention is not limited to the particular embodiments described hereinbefore.

We claim:

1. Apparatus comprising of:
a protective apparatus;
detecting means for detecting a subject; and
decision-making means for outputting a compliance indication.

2. The apparatus of claim 1 further comprising of a controller for receiving said compliance indication from said decision-making means.

3. The apparatus of claim 2 further comprising of a driver.

4. The apparatus of claim 3 wherein the controller and driver comprise a single device.

5. The apparatus of any one of claims 3 to 4 further comprising of an interface, activated by said driver for communicating with a second apparatus.

6. The apparatus according to claim 5 wherein said interface is a relay.

7. The apparatus of claim 5 wherein said interface is in communication with a second apparatus.

8. The apparatus of claim 1 wherein said sensing means for detecting said subject provides a sensing output when in proximity to certain anatomical features of said subject.

9. The apparatus of claim 1 wherein said sensing means for detecting said subject conforms to certain anatomical features of said subject.

10. Apparatus comprising of:
detection means for detecting a first protective apparatus;
detection means for detecting a subject;
monitoring means for monitoring engagement of said protective apparatus with said subject; and
a controller for controlling the operability of a second apparatus according to said monitoring means.

11. The apparatus according to any one of claims 1 to 10 wherein the elements are linked.

12. The apparatus according to claim 11 wherein the link is established by a code.

13. The apparatus according to any one of claims 1 to 12 wherein the protective apparatus is eyewear.

14. The apparatus according to any one of claims 1 to 13 wherein the protective apparatus attenuates or reflects sound.

15. The apparatus according to any one of claims 1 to 13 wherein the protective apparatus attenuates x-rays.

16. The apparatus according to any one of claims 1 to 13 wherein the protective apparatus attenuates, reflects or otherwise protects against a hazardous phenomenon.

17. The apparatus according to any one of claims 1 to 14 further comprising of a power source.

18. A method for safety compliance comprising the steps of:
detecting a subject;
determining the position of said subject in relation to protective apparatus;
determining the compliance state of the engagement of said protective apparatus and
controlling a second apparatus according to the compliance state of said protective apparatus.

19. A method for safety compliance comprising the steps of:
detecting a first apparatus;
detecting the position of said first apparatus;
engaging said first apparatus with a subject; and
controlling a second apparatus according to the position of said safety apparatus.

20. The method of claim 19 wherein said first apparatus is protective apparatus.
